(19) United States
(12) Patent Application Publication
(10) Pub. No.: US 2021/0397973 A1
(43) Pub. Date: Dec. 23, 2021

(54) STORAGE MEDIUM, OPTIMUM SOLUTION ACQUISITION METHOD, AND OPTIMUM SOLUTION ACQUISITION APPARATUS

(71) Applicant: FUJITSU LIMITED, Kawasaki-shi (JP)

(72) Inventor: Eiji OHTA, Yokohama (JP)

(73) Assignee: FUJITSU LIMITED, Kawasaki-shi (JP)

(21) Appl. No.: 17/206,182

(22) Filed: Mar. 19, 2021

(30) Foreign Application Priority Data
Jun. 23, 2020 (JP) 2020-107713

(51) Int. Cl. G06N 3/08; G06N 3/04

(52) U.S. Cl. CPC G06N 3/088; G06N 3/0454

(57) ABSTRACT

A non-transitory computer-readable storage medium storing a program that causes a computer to execute a process, the process includes learning a variational autoencoder (VAE) by using a plurality of pieces of training data including an objective function; identifying, by inputting the plurality of pieces of training data to the learned VAE, a distribution of the plurality of pieces of training data over a latent space of the learned VAE; determining a search range of an optimum solution of the objective function based on the distribution of the plurality of pieces of training data; and acquiring an optimum solution of a desired objective function by using the pieces of training data included in the search range.

### CROSS-REFERENCE TO RELATED APPLICATION

This application is based upon and claims the benefit of priority of the prior Japanese Patent Application No. 2020-107713, filed on Jun. 23, 2020, the entire contents of which are incorporated herein by reference.

### FIELD

The embodiments discussed herein are related to a computer-readable recording medium, an optimum solution acquisition method, and an optimum solution acquisition apparatus.

### BACKGROUND

In the past, an optimization problem that finds a best solution (optimum solution) for a desirability scale (objective function) under a given condition (constraint) has been known. Generally, when there is no interaction between variables, the optimum solution for the objective function may be relatively easily found even by using any optimization method. However, in many problems, since there is the interaction between the variables even though the interaction is not quantitatively known, a solution space that is a surface of the objective function formed by a combination set of variables is a multimodal space in which there are a plurality of mountains and a plurality of valleys. Accordingly, in recent years, a searching method is devised, and thus, techniques such as mathematical programming, metaheuristic such as simulated annealing and genetic algorithm, and response surface methodology of rapidly acquiring the optimum solution by reducing the number of times of searches have been utilized. For example, Japanese Laid-open Patent Publication No. 2019-8499, Japanese Laid-open Patent Publication No. 2010-146068, and the like have been disclosed.

### SUMMARY

According to an aspect of the embodiments, a non-transitory computer-readable storage medium storing a program that causes a computer to execute a process, the process includes learning a variational autoencoder (VAE) by using a plurality of pieces of training data including an objective function;

identifying, by inputting the plurality of pieces of training data to the learned VAE, a distribution of the plurality of pieces of training data over a latent space of the learned VAE; determining a search range of an optimum solution of the objective function based on the distribution of the plurality of pieces of training data; and acquiring an optimum solution of a desired objective function by using the pieces of training data included in the search range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an information processing apparatus according to a first embodiment;

FIG. 2 is a diagram for explaining machine learning of a VAE according to a reference technique;

FIG. 3 is a diagram for explaining acquisition of an optimum solution according to the reference technique;

FIG. 4 is a diagram for explaining the acquisition of the optimum solution according to the reference technique;

FIG. 5 is a diagram for explaining a trouble of the reference technique;

FIG. 6 is a functional block diagram illustrating a functional configuration of the information processing apparatus according to the first embodiment;

FIG. 7 is a diagram for explaining a generation example of training data;

FIG. 8 is a diagram for explaining a generation example of a set of objective functions;

FIG. 9 is a diagram for explaining a generation example of a set of characteristic values;

FIG. 10 is a diagram for explaining an example of imaging of a set of variables;

FIG. 11 is a diagram for explaining an example of imaging of the set of objective functions;

FIG. 12 is a diagram for explaining an example of imaging of the set of characteristic values;

FIG. 13 is a diagram for explaining learning of a VAE;

FIG. 14 is a diagram for explaining sparseness or denseness of pieces of training data;

FIG. 15 is a diagram for explaining acquisition of an optimum solution;

FIG. 16 is a flowchart illustrating a flow of overall processing;

FIG. 17 is a flowchart illustrating a flow of processing of generating the training data;

FIG. 18 is a flowchart illustrating a flow of processing of acquiring the optimum solution;

FIG. 19 is a diagram for explaining calculation of the sets of objective functions, variables, and characteristic values;

FIG. 20 is a diagram illustrating a circuit diagram used in a specific example;

FIG. 21 is a diagram for explaining a structure of a VAE that generates a latent space and losses;

FIG. 22 is a diagram for explaining a distribution of pieces of validation data in the latent space;

FIG. 23 is a diagram for explaining restored images of learning data;

FIG. 24 is a diagram for explaining restored images of node waveforms in the latent space;

FIG. 25 is a diagram for explaining restored images of parameters and power efficiencies in the latent space;

FIG. 26 is a diagram for explaining a distribution of Lm parameters in the latent space;

FIG. 27 is a diagram for explaining a distribution of Lr parameters in the latent space;

FIG. 28 is a diagram for explaining a distribution of Cr parameters in the latent space;

FIG. 29 is a diagram for explaining a distribution of the power efficiencies in the latent space;

FIG. 30 is a diagram for explaining the power efficiency distribution and random extraction;

FIG. 31 is a diagram for explaining simulation values and estimated values of the power efficiency distribution;

FIG. 32 is a diagram for explaining errors between the estimated values and the simulation values;

FIG. 33 is a diagram for explaining a comparison in power efficiency between the estimated values and the simulation values;

FIG. 34 is a diagram for explaining the acquisition of the optimum solution; and

FIG. 35 is a diagram for explaining an example of a hardware configuration.

### DESCRIPTION OF EMBODIMENTS

However, an effect of rapidly acquiring the optimum solution in the above-described techniques depends on the complexity of the solution space. Thus, in the case of the complex solution space, the numbers of times of captures and searches of local solutions increase, and it takes an enormous amount of time for optimization. For example, when the solution space is a space like the multimodal space in which whether there is optimization is not known, it takes an enormous amount of time, and there is a possibility that the optimum solution may not be acquired from the very first.

In view of the above circumstances, it is desirable to shorten the time taken to acquire the optimum solution.

Hereinafter, embodiments of an optimum solution acquisition program, an optimum solution acquisition method, and an information processing apparatus disclosed herein will be described in detail with reference to the drawings. These embodiments do not limit the present disclosure. The embodiments may be combined with each other as appropriate within the scope without contradiction.

### First Embodiment

### Description of Information Processing Apparatus

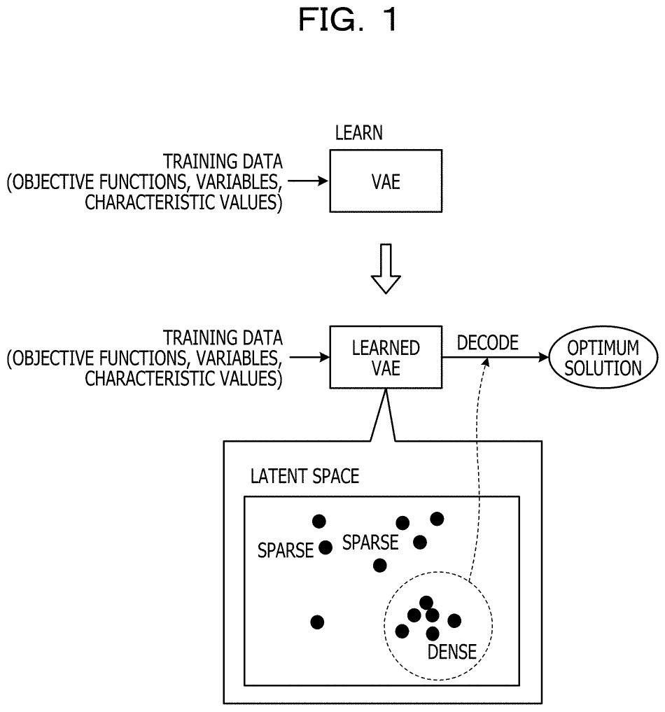

FIG. 1 is a diagram for explaining an information processing apparatus 10 according to a first embodiment. The information processing apparatus 10 illustrated in FIG. 1 is an example of a computer apparatus that finds an optimum solution for a scale (objective function) desired by a user by learning a learning model using a variational autoencoder (VAE).

The VAE learns feature amounts of pieces of input data by performing dimension compression of the pieces of input data to a latent space. This is a feature in that pieces of data with high degrees of similarity are located at arbitrary points in the latent space in a concentrated manner. Such a feature is focused on, and it is considered to learn the VAE by giving an objective function corresponding to correct answer information and variables and characteristic values which are examples of parameters that influence the objective function to pieces of training data of the VAE.

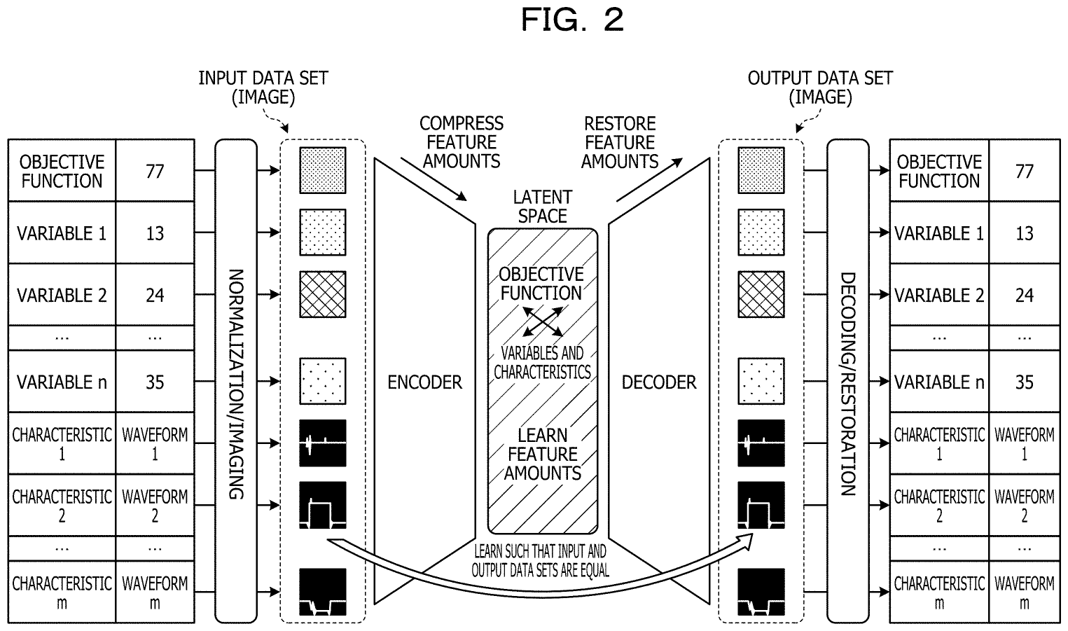

FIG. 2 is a diagram for explaining machine learning of a VAE according to a reference technique. As illustrated in FIG. 2, in the reference technique, an input data set of images is generated by performing normalization and imaging on pieces of training data including an objective function, variables 1 to n, and characteristics 1 to n, and the compression of feature amounts is executed by inputting the input data set to an encoder of the VAE. In the reference technique, an output data set is restored from the feature amounts by inputting the compressed feature amounts to a decoder of the VAE, and the objective function, the variables 1 to n, and the characteristics 1 to n are acquired by decoding and restoring the output data set. At this time, in the reference technique, machine learning is executed in the encoder and the decoder such that the input data set matches the output data set. For example, machine learning of a neural network used in the encoder and the decoder is executed.

Here, in the reference technique, it is considered to acquire an optimum solution of the objective function desired by the user by inference by using the learned VAE machine-learned by using the above-described pieces of training data including the objective function. As an example, the acquisition of the optimum solution that maximizes the objective function will be described.

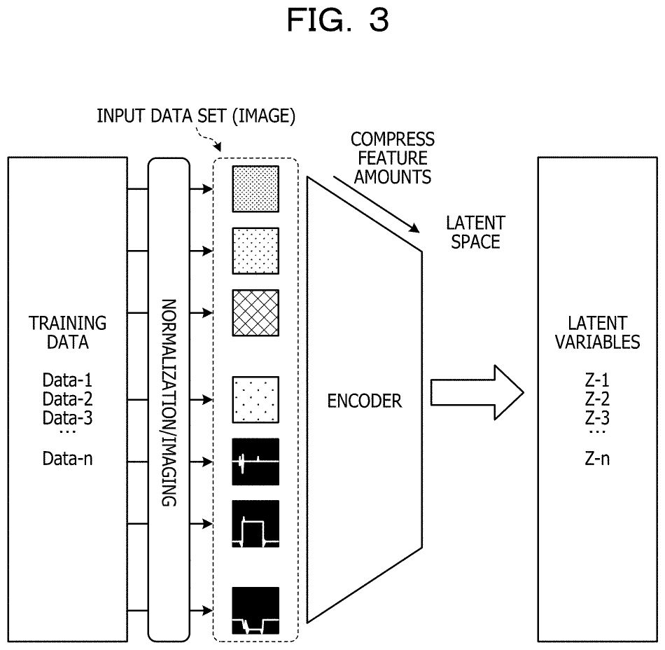

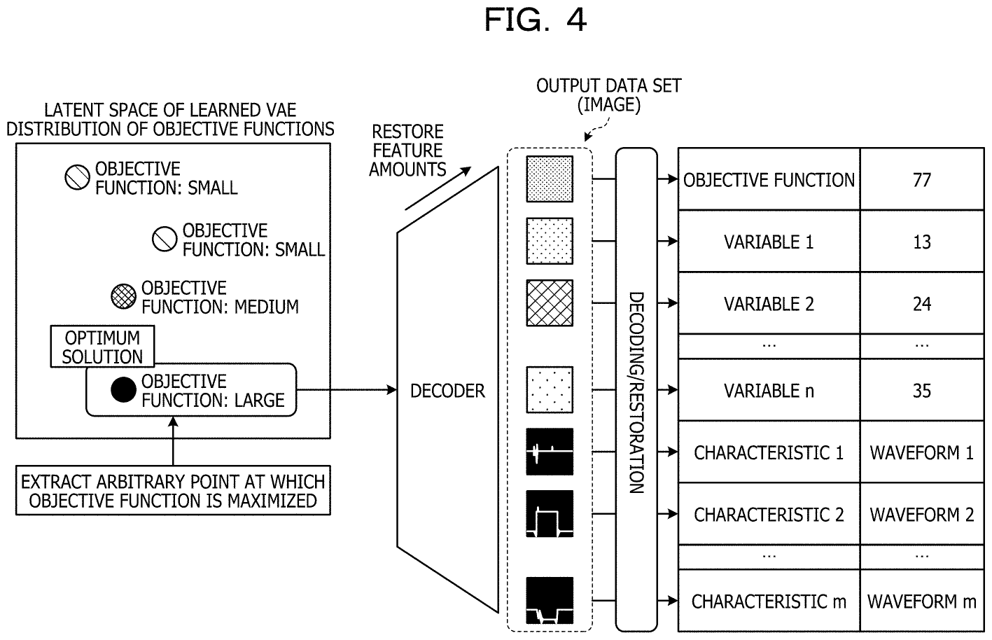

FIGS. 3 and 4 are diagrams for explaining the acquisition of the optimum solution according to the reference technique. As illustrated in FIG. 3, in the reference technique, latent variables (Z-1 to Z-n) are acquired by inputting pieces of training data (Data-1 to Data-n) to the encoder of the learned VAE. It is assumed that the latent variable generated from the training data Data-1 is Z-1, the latent variable generated from the training data Data-2 is Z-2, and the latent variable generated from the training data Data-n is Z-n.

In the reference technique, a solution space in which objective functions with high degrees of similarity are located in a concentrated manner by using the latent space of the learned VAE (high parts and low parts of the objective functions are concentrated). As illustrated in FIG. 4, in the reference technique, the latent variable that maximizes the objective function is specified in the solution space, and the latent variable is restored by being input to the decoder of the learned VAE.

As described above, in the reference technique, since an arbitrary point in the latent space is given as an input to the decoder of the learned VAE and “variables, characteristic values” that give an optimum value of the objective function are acquired by inference by using the decoder of the learned VAE, the optimum solution may be rapidly acquired even in the complex solution space.

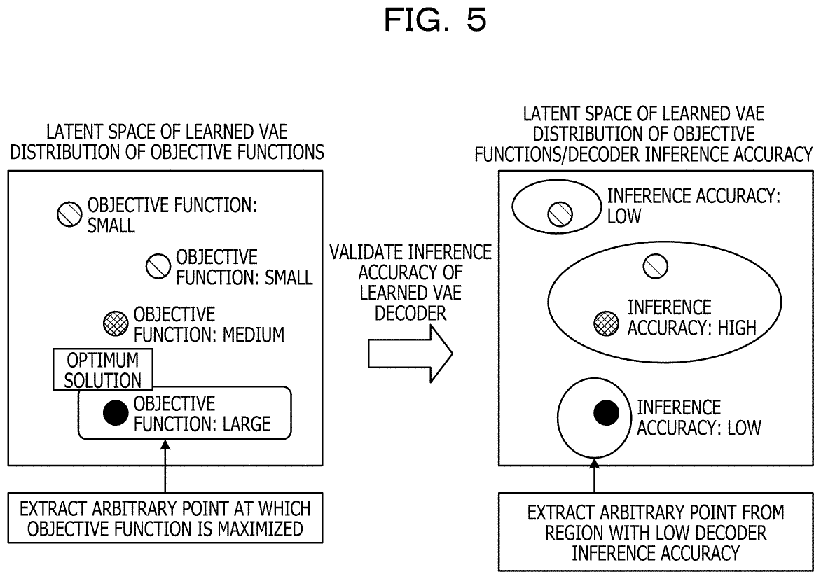

However, in the latent space, since an inference accuracy distribution of the decoder corresponding to arbitrary points is non-uniform and a local fluctuation, a partial region distribution, and the like are unknown, an accurate optimum solution may not be acquired. FIG. 5 is a diagram for explaining a trouble of the reference technique. As illustrated in FIG. 5, in the reference technique, arbitrary points at which the objective function is maximized are extracted from the distribution of the objective functions in the latent space of the learned VAE. Incidentally, when the inference accuracy distribution of the decoder in the latent space of the learned VAE is considered, the extracted arbitrary points may correspond to a region in which the inference accuracy is low, and in this case, the optimum solution restored based on the arbitrary point may not be accurate. Since the inference accuracy distribution of the decoder is generally unknown, it may be difficult to accurately acquire the optimum solution in the reference technique.

Thus, the information processing apparatus 10 according to the first embodiment learns the VAE by using a plurality of pieces of training data including the objective function, inputs the plurality of pieces of training data to the learned VAE, and specifies a distribution of the plurality of pieces of training data over the latent space of the learned VAE. The information processing apparatus 10 decides a search range of the optimum solution of the objective function according to the distribution of the plurality of pieces of training data, and acquires the optimum solution of the desired objective function by using the pieces of training data included in the decided search range.

For example, the information processing apparatus 10 maps the latent variables corresponding to the pieces of training data to the latent space (distribution of the objective functions) of the learned VAE. The information processing apparatus 10 discriminates an adoption possibility of an optimum solution candidate at the arbitrary point in the latent space based on the sparseness or denseness of the distribution of the pieces of training data in a neighboring region while focusing on the fact that the inference accuracy of the decoder of the learned VAE is low in a region in which the distribution of the pieces of training data is sparse and the inference accuracy is high in a region of the distribution of the pieces of training data is dense. As a result, the information processing apparatus 10 may shorten the time taken to acquire the optimum solution and may acquire the accurate optimum solution.

### Functional Configuration

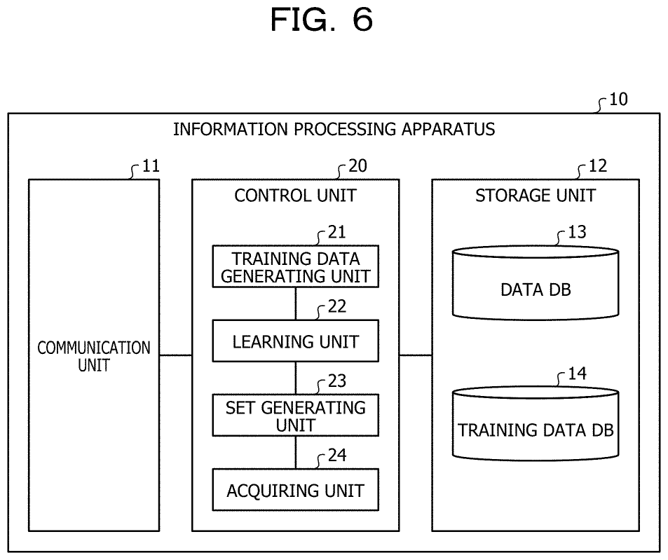

FIG. 6 is a functional block diagram illustrating a functional configuration of the information processing apparatus 10 according to the first embodiment. As illustrated in FIG. 6, the information processing apparatus 10 includes a communication unit 11, a storage unit 12, and a control unit 20.

The communication unit 11 is a processing unit that controls communication with other apparatuses and is, for example, a communication interface or the like. For example, the communication unit 11 receives a start request of each process from a terminal of an administrator and transmits a learning result, an acquisition result of the optimum solution, and the like to the terminal of the administrator.

The storage unit 12 is a processing unit that stores pieces of data, a program executed by the control unit 20, and the like, and is achieved by, for example, a memory, a hard disk, or the like. For example, the storage unit 12 stores a data DB 13 and a training data DB 14.

The data DB 13 is a database that stores pieces of learning data that are generation sources of the pieces of training data. For example, the data DB 13 stores pieces of sensing data sensed by various sensors and the like, various kinds of data input by the administrator, and the like.

The training data DB 14 is a database that stores the pieces of training data used for learning of the VAE. For example, the training data DB 14 stores the pieces of training data generated from the pieces of data stored in the data DB 13 by a training data generating unit 21 to be described below.

The control unit 20 is a processing unit that manages the entire information processing apparatus 10 and is achieved by, for example, a processor or the like. The control unit 20 has the training data generating unit 21, a learning unit 22, a set generating unit 23, and an acquiring unit 24. The training data generating unit 21, the learning unit 22, the set generating unit 23, and the acquiring unit 24 are achieved by electronic circuits included in the processor, processes executed by the processor, and the like.

The training data generating unit 21 is a processing unit that generates the pieces of training data by using the pieces of data stored in the data DB 13. For example, the training data generating unit 21 specifies the objective function, the variables, and the characteristic values from the pieces of data stored in the data DB 13, generates pieces of image data corresponding to the objective functions, the variables, and the characteristic values to be input to the VAE, respectively, and stores the pieces of image data as the pieces of training data in the training data DB 14.

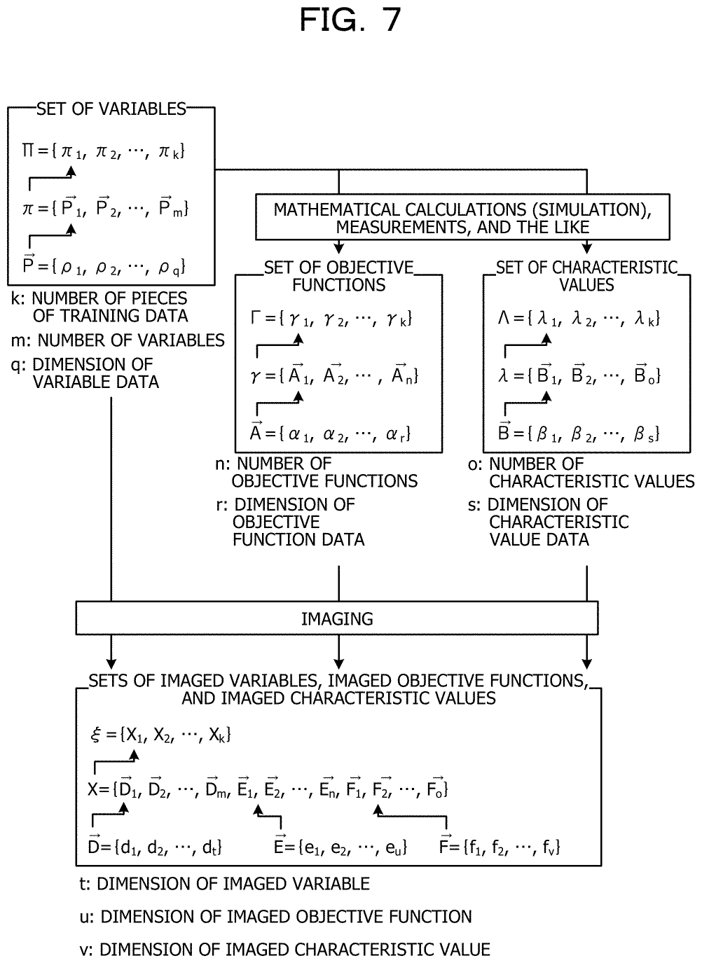

FIG. 7 is a diagram for explaining a generation example of training data. As illustrated in FIG. 7, the training data generating unit 21 sets a fluctuation range of each variable (such as Π) of the objective functions, the variables, the characteristic values, and the like, and generates a set of variables. “k” in the set of variables indicates the number of pieces of training data, “m” indicates the number of variables, and “q” indicates a dimension of variable data.

Subsequently, the training data generating unit 21 generates a set of objective functions (γ) and a set of characteristic values (Λ) by performing mathematical calculations, measurements, and the like on the set of variables. “n” in the set of objective functions indicates the number of objective functions, “r” indicates a dimension of objective function data, “o” in the set of characteristic values indicates the number of characteristic values, and “s” indicates a dimension of characteristic value data.

Thereafter, the training data generating unit 21 images each of the set of variables, the set of objective functions, and the set of characteristic values, generates sets of imaged variables, imaged objective functions, and imaged characteristic values, and generates the set as training data. “t” indicates a dimension of the imaged variable, “u” indicates a dimension of the imaged objective function, and “v” indicates a dimension of the imaged characteristic value.

### Specific Example of Training Data Generation

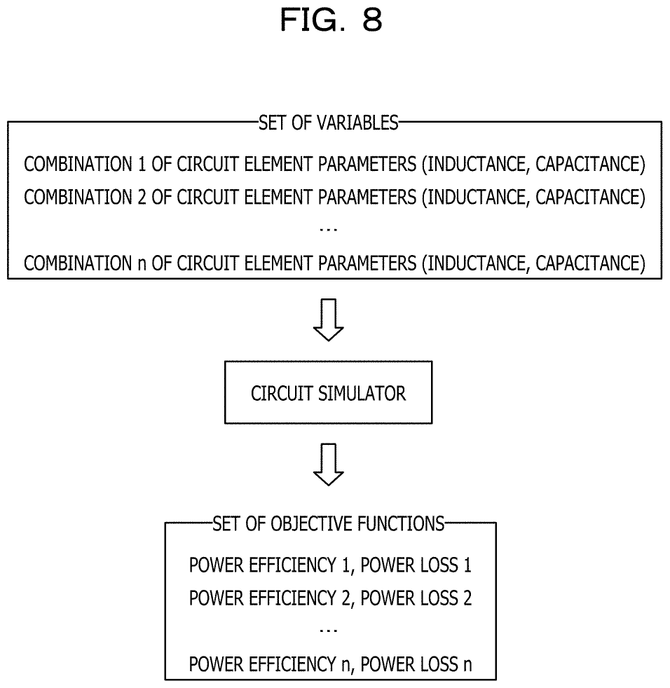

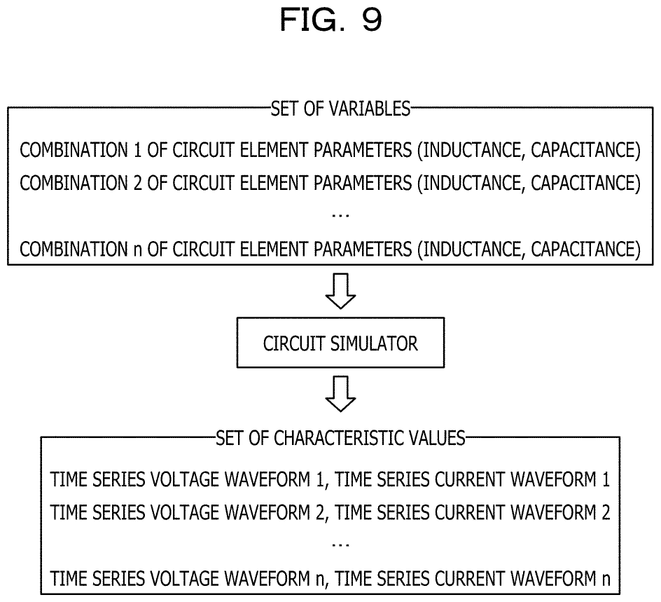

A specific example of the aforementioned training data generation will be described with reference to FIGS. 8 to 12. As an example, optimization of design parameters in a circuit design will be described. FIG. 8 is a diagram for explaining a generation example of the set of objective functions. FIG. 9 is a diagram for explaining a generation example of the set of characteristic values.

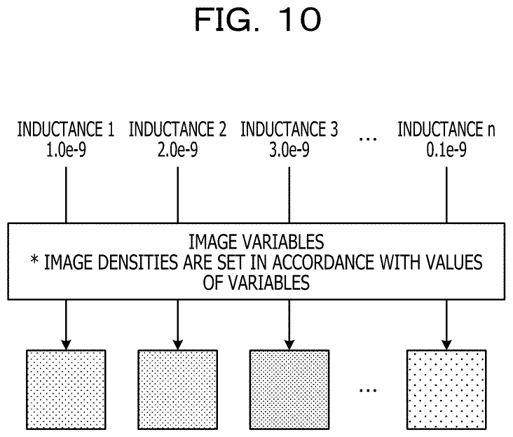

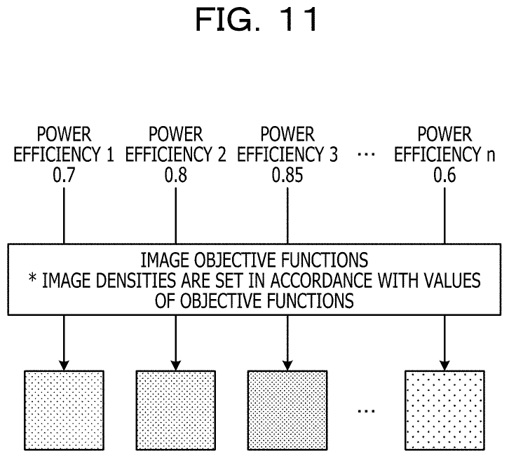

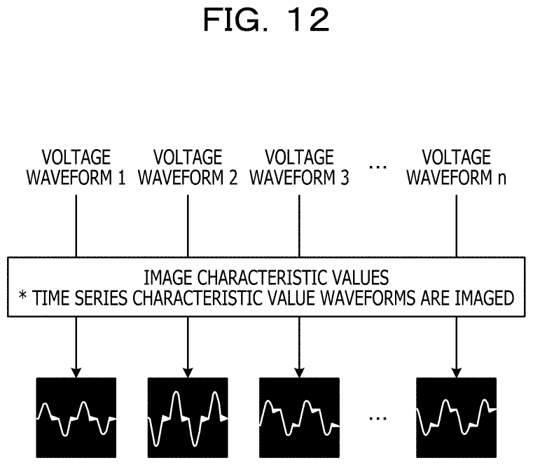

FIG. 10 is a diagram for explaining an example of imaging of the set of variables. FIG. 11 is a diagram for explaining an example of imaging of the set of objective functions. FIG. 12 is a diagram for explaining an example of imaging of the set of characteristic values.

First, the training data generating unit 21 generates the set of variables, the set of objective functions, and the set of characteristic values. For example, as illustrated in FIG. 8, the training data generating unit 21 generates n “combinations of circuit element parameters (inductance, capacitance) as the set of variables. The training data generating unit 21 inputs the set of variables to a circuit simulator such as LTspice (registered trademark) or the like and generates n combinations of “power efficiency, power loss” as the set of objective functions.

Similarly, as illustrated in FIG. 9, the training data generating unit 21 inputs the set of variables “combinations 1 to n of circuit element parameters (inductance, capacitance)” to the circuit simulator or the like and generates n combinations of “time series voltage waveforms (hereinafter, may be simply referred to as “voltage waveforms”), time series current waveforms (hereinafter, may be simply referred to as “current waveforms”)” as the set of characteristic values.

Subsequently, the training data generating unit 21 images each of the set of variables, the set of objective functions, and the set of characteristic values and generates the imaged variables, the imaged objective functions, and the imaged characteristic values. For example, as illustrated in FIG. 10, the training data generating unit 21 images each of n inductances 1 to n, which is one of the variables, by setting an image density in accordance with a value of the variable. The capacitance, which is the other variable, is similarly imaged.

As illustrated in FIG. 11, the training data generating unit 21 images each of n power efficiencies 1 to n, which is one of the objective functions, by setting an image density in accordance with a value of the objective function. The power loss, which is the other objective function, is similarly imaged.

As illustrated in FIG. 12, the training data generating unit 21 images each of n voltage waveforms 1 to n, which is one of the characteristic values such that each waveform is represented. The current waveform, which is the other characteristic value, is similarly imaged.

Referring back to FIG. 6, the learning unit 22 is a processing unit that learns the VAE by using the pieces of training data stored in the training data DB 14. For example, the learning unit 22 inputs “imaged variables, imaged objective functions, imaged characteristic values” which are the pieces of training data to the VAE and learns the VAE. After the learning is completed, the learning unit 22 stores, as the learning result, the learned VAE or various parameters included in the learned VAE in the storage unit 12. A timing at which the learning is completed may be set at any time, such as a time at which learning using a predetermined or higher number of pieces of training data is completed or a time at which a restoration error is less than a threshold.

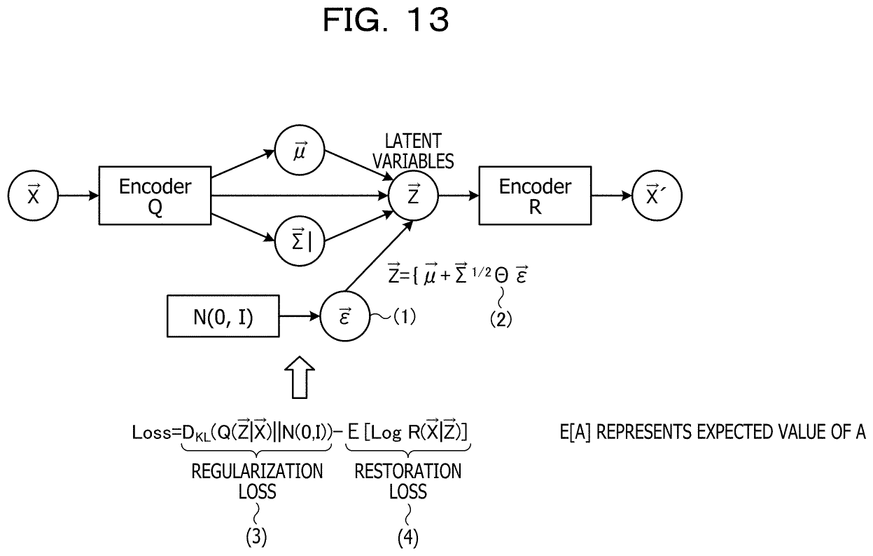

The VAE to be learned will be described. FIG. 13 is a diagram for explaining the learning of the VAE. In explaining FIG. 13, a vector X or the like may be simply referred to as “X” as appropriate. As illustrated in FIG. 13, the VAE has the encoder and the decoder. When input data (vector X) is input, the encoder generates parameters μ (vector) and Σ (vector) having a normal distribution followed by a latent variable Z. For example, the encoder compresses a feature of the input data (vector X), outputs a mean p and a dispersion Σ of an N-dimensional Gaussian distribution, and finds the latent variable Z by sampling based on the two mean and dispersion. The decoder restores the input data from the sampled latent variable. The VAE adjusts a weight for each of a neural network of the encoder and the decoder by error back-propagation using a difference between the input data and the restored data.

For example, (1) of FIG. 13 indicates an n-dimensional vector sampled randomly from an n-dimensional standard normal distribution Nₙ(0, I). (2) of FIG. 13 indicates a product (Hadamard product) of elements of the two vectors, and the vector Z is equivalent to an n-dimensional vector sampled randomly from an n-dimensional normal distribution Nₙ(vector μ, vector Σ) of the mean p and the dispersion Σ.

D_{KL}(P|Q) in (3) of FIG. 13 is a Kullback-Leibler distance of two probability distributions P and Q (hereinafter, may be referred to as a “KL distance”) and is a scale for measuring a difference between P and Q. The KL distance is zero when P and Q completely match and otherwise has a positive value. Due to minimization of a regularization loss, images having high similarity are decoded to close points in the latent space. (4) of FIG. 13 indicates that a mean squared error, a cross entropy error, or the like between the input X and the output X′ is used as an approximation of a restoration loss. The cross entropy error is used in an example of a circuit design to be described below. E[A] represents an expected value of A.

In the VAE designed as described above, the parameters of the encoder and the decoder are learned such that Loss is minimized for a set ζ={X₁, X₂, . . . , Xₙ} of the pieces of training data. The encoder and the decoder include a hierarchical neural network (NN). A procedure for adjusting parameters of weights and biases of the NN such that Loss is minimized is a learning process of the VAE.

Referring back to FIG. 6, the set generating unit 23 is a processing unit that generates a sampling set by using the learned VAE. For example, the set generating unit 23 inputs the pieces of training data to the learned VAE, specifies the distribution of the pieces of training data over the latent space of the learned VAE, and decides the search range of the optimum solution of the objective function according to the distribution of the pieces of training data.

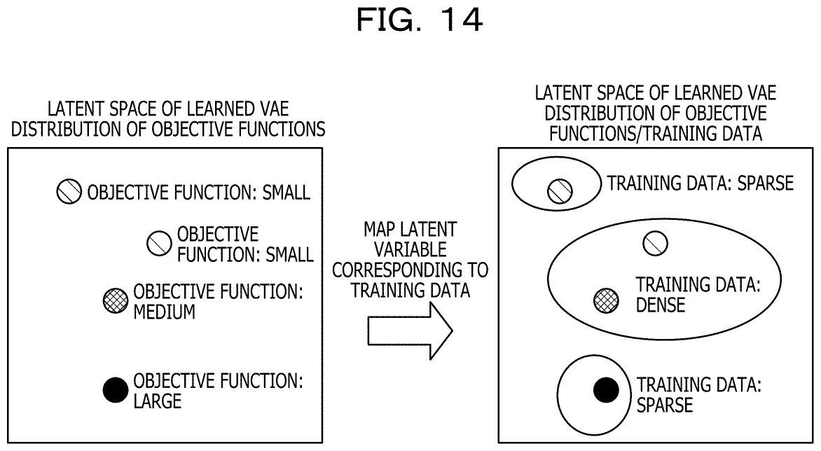

FIG. 14 is a diagram for explaining the sparseness or denseness of the pieces of training data. As illustrated in FIG. 14, the set generating unit 23 maps the latent variables which correspond to the plurality of pieces of training data generated by the encoder of the learned VAE, respectively, in response to the input of the plurality of pieces of training data to the latent space of the encoder of the learned VAE. For example, the set generating unit 23 specifies the distribution of the pieces of training data over the latent space by mapping the distribution of the respective objective functions of the pieces of training data over the latent space of the learned VAE to the latent variables corresponding to the pieces of training data. The set generating unit 23 determines the sparseness and denseness of the pieces of training data over the latent space, and generates, as the sampling set, the pieces of training data belonging to the dense region.

As an example, the set generating unit 23 selects a plurality of arbitrary points satisfying a predetermined condition, such as points at which the value of the objective function is equal to or greater than a threshold, in the distribution of the pieces of training data over the latent space. Subsequently, the set generating unit 23 counts the number of pieces of training data present within a certain distance range (each region) for each selected arbitrary point with an arbitrary point as a center. The set generating unit 23 may decide, as the search range, a region in which the number of pieces of training data is largest.

The acquiring unit 24 is a processing unit that acquires the optimum solution of the objective function by using the learned VAE. For example, the acquiring unit 24 restores the sets of imaged variables, imaged objective functions, and imaged characteristic values from the sampling set by performing decoding by using the learned VAE on the sampling set generated by the set generating unit 23. The acquiring unit 24 converts the sets of the imaged variables, imaged objective functions, and imaged characteristic values into numerical values and acquires a combination of the objective function, the variable, and the characteristic value which is the optimum solution.

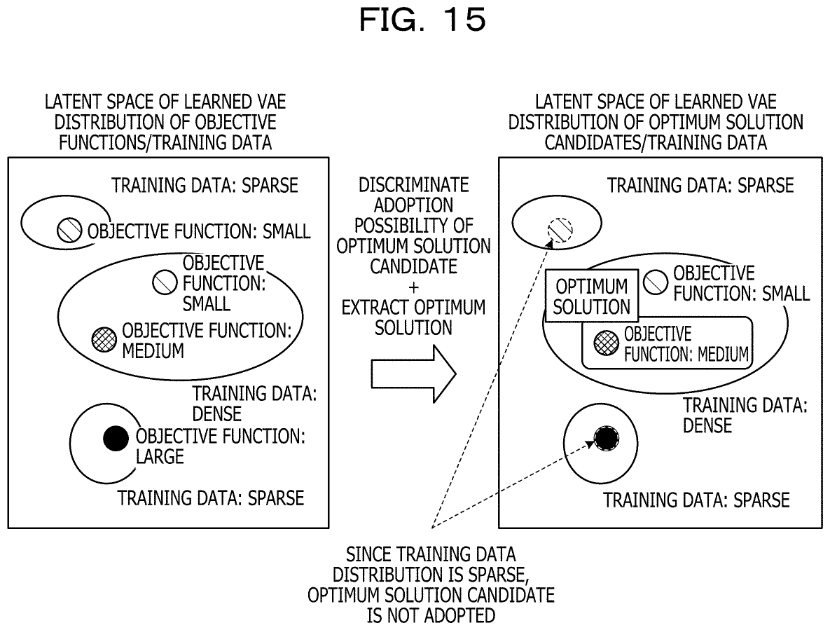

FIG. 15 is a diagram for explaining the acquisition of the optimum solution. As illustrated in FIG. 15, the acquiring unit 24 may also extract the training data with the largest value of the objective function among the plurality of pieces of training data belonging to the region in which the number of pieces of training data is largest (for example, dense region). For example, the acquiring unit 24 excludes (does not adopt) the pieces of training data in a region where the density of the pieces of training data is sparse. The acquiring unit 24 may also acquire the combination of the objective function, the variable, and the characteristic value that is then optimum solution by inputting the latent variables (feature amounts) of the extracted training data to the decoder of the learned VAE and restoring the latent variables. The acquiring unit 24 stores the acquired optimum solution in the storage unit 12, displays the optimum solution on a display, or transmits the optimum solution to the administrator terminal.

### Example of Processing

Next, a flow of processing executed in each processing unit described above will be described. Overall processing, processing of generating the training data, and processing of acquiring the optimum solution will be described.

### Overall Processing

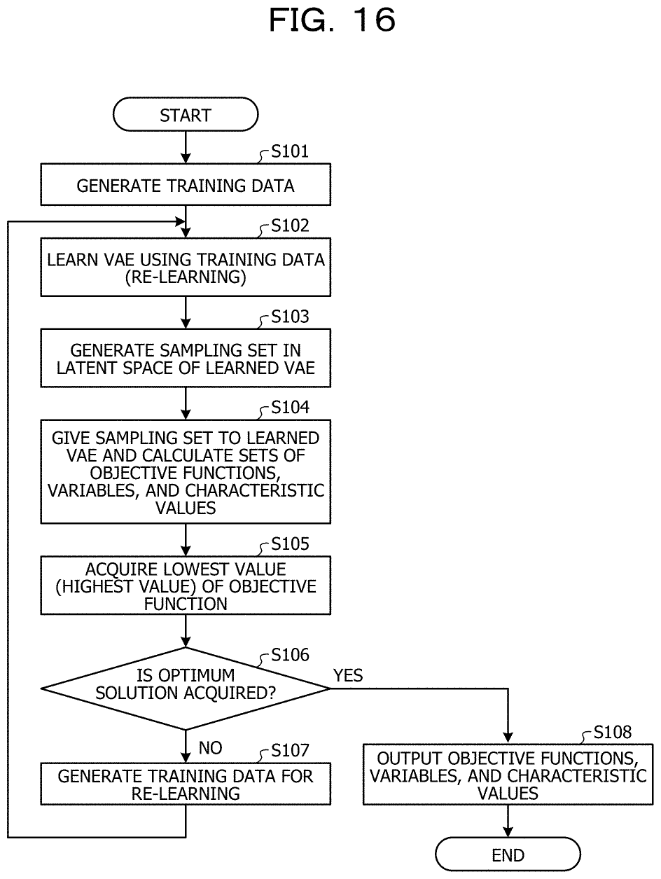

FIG. 16 is a flowchart illustrating a flow of overall processing. As illustrated in FIG. 16, when the processing starts, the training data generating unit 21 executes the generation of the pieces of training data (S101), and the learning unit 22 executes the learning of the VAE using the pieces of training data (S102).

Subsequently, the set generating unit 23 generates the sampling set in the latent space of the learned VAE (S103). The acquiring unit 24 gives the sampling set to the learned VAE and calculates the sets of objective functions, variables, and characteristic values (S104) and acquires a lowest value (or a highest value) of the objective function (S105).

When the optimum solution may not be acquired (No in S106), the training data generating unit 21 generates pieces of training data for re-learning by performing resetting such as increasing the fluctuation range of each variable (S107). Thereafter, the processing in S102 and subsequent steps is repeated.

When the optimum solution may be acquired (Yes in S106), the acquiring unit 24 outputs the acquired sets of the objective functions, variables, and characteristic values (S108).

### Processing of Generating Training Data

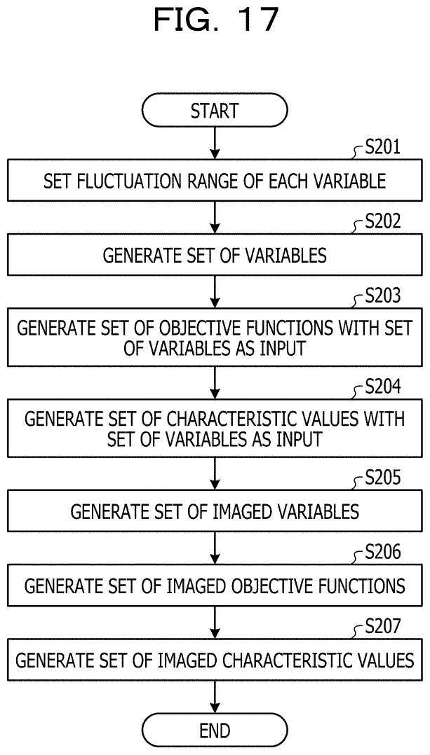

FIG. 17 is a flowchart illustrating a flow of processing of generating the pieces of training data. As illustrated in FIG. 17, the training data generating unit 21 sets the fluctuation ranges of each variable (S201) and generates the set of variables (S202).

Subsequently, the training data generating unit 21 generates the set of objective functions by performing mathematical calculations, measurements, and the like with the set of variables as the input (S203). The training data generating unit 21 generates the set of characteristic values by performing mathematical calculations, measurements, and the like with the set of variables as the input (S204).

The training data generating unit 21 generates the set of imaged variables from the set of variables (S205), generates the set of imaged objective functions from the set of objective functions (S206), and generates the set of imaged characteristic values from the set of characteristic values (S207).

### Process of Acquiring Optimum Solution

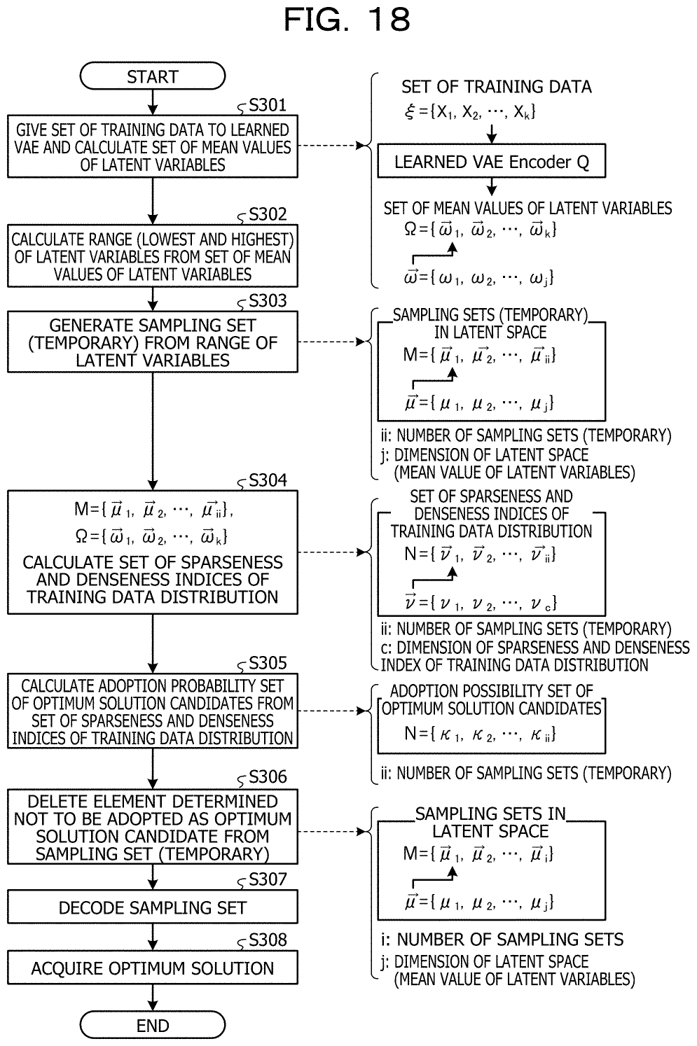

FIG. 18 is a flowchart illustrating a flow of processing of acquiring the optimum solution. As illustrated in FIG. 18, the set generating unit 23 gives a set of pieces of training data to the learned VAE and calculates a set of mean values of the latent variables (S301). For example, the set generating unit 23 inputs a set of pieces of training data ζ={X₁, X₂, . . . , Xₙ} to the encoder of the learned VAE and acquires a set Ω of mean values of the latent variables.

Subsequently, the set generating unit 23 calculates a range (lowest and highest) of the latent variables from the set of mean values of the latent variables (S302). The set generating unit 23 generates the sampling set (temporary) from the range of the latent variables (S303). For example, the set generating unit 23 generates a sampling set (temporary) M of the range corresponding to the objective function desired by the user. In this case, “ii” is the number of sampling sets (temporary), and “j” is a dimension of the latent space (mean values of the latent variables).

Thereafter, the set generating unit 23 calculates a set of sparseness and denseness indices of portions of the pieces of training data by using the sampling set (temporary) M in the latent space generated in S303 and the set Ω of mean values of the latent variables generated in S301 (S304). For example, the set generating unit 23 generates a set N of sparseness and denseness indices of the training data distribution. ii is the number of sampling sets (temporary), and c is a dimension of the sparseness and denseness index of the training data distribution.

Subsequently, the set generating unit 23 calculates an adoption possibility set of optimum solution candidates from the set of sparseness and denseness indices of the training data distribution (S305). For example, the set generating unit 23 generates an adoption possibility set K of optimum solution candidates by using ii that is the number of sampling sets (temporary).

The set generating unit 23 deletes elements determined not to be adopted as the optimum solution candidate from the sampling set (temporary) and generates the sampling set (S306). For example, the set generating unit 23 generates the sampling set M from which the elements determined not to be adopted among the adoption possibility set K of optimum solution candidates are deleted from the sampling set (temporary). In this case, “i” is the number of sampling sets, and “j” is the dimension of the latent space (mean values of the latent variables). Thereafter, the acquiring unit 24 decodes the sampling set (S307) and acquires the optimum solution (S308).

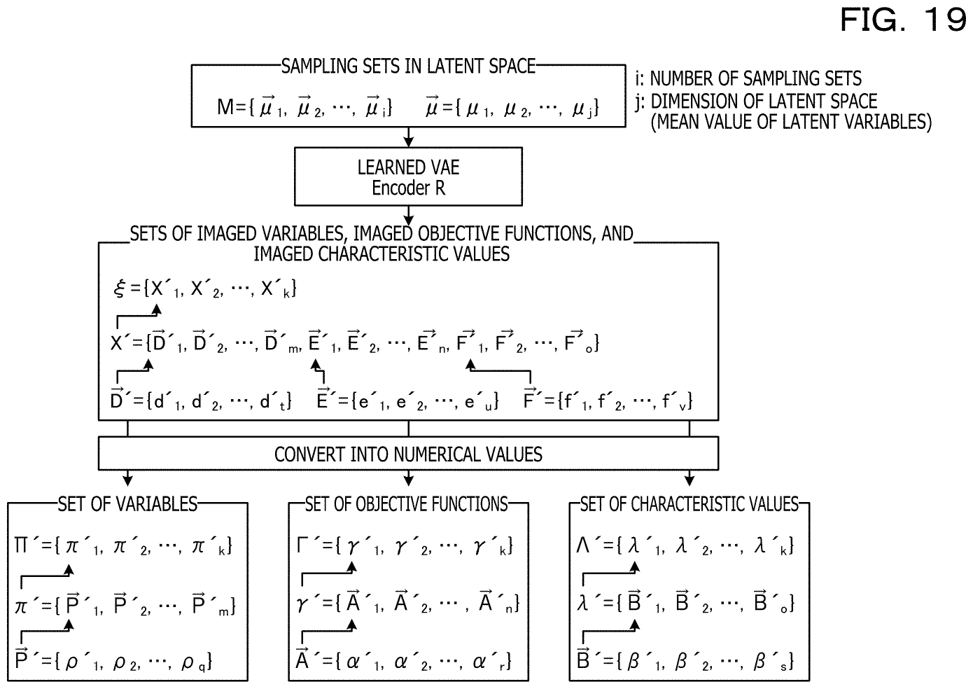

FIG. 19 is a diagram for explaining the calculation of the sets of objective functions, variables, and characteristic values. As illustrated in FIG. 19, the acquiring unit 24 inputs the sampling set M in the latent space to the decoder of the learned VAE and acquires a set ζ={X′₁, X′₂, . . . , X′ₙ} of imaged variables D′(d′₁ to d′ₙ), imaged objective functions E′(e′₁ to e′ₙ), and imaged characteristic values F′(f′₁ to f′ₙ) as a restoration result. X′ includes {D′_{1 to m}, E′_{1 to n}, F′_{1 to o}}. The acquiring unit 24 converts the sets of imaged variables D′, imaged objective functions E′, and imaged characteristic values F′ into numerical values, respectively, and generates a set Π′ of variables π′₁ to π′ₙ, a set Γ of objective functions γ′₁ to γ′ₙ, and a set Λ of characteristic values λ′₁ to λ′ₙ.

### Specific Example

Next, a specific example of the acquisition of the optimum solution described above will be described. Optimization of design parameters in a circuit design of an LLC current resonance circuit will be described as an example.

### Circuit Diagram

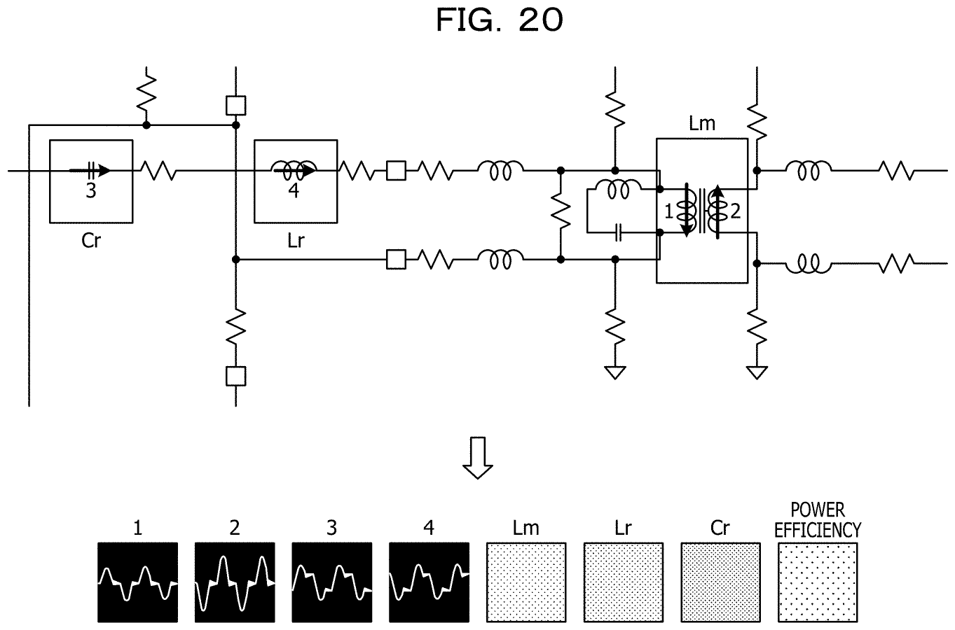

A circuit diagram to be designed will be described first. FIG. 20 is a diagram illustrating a circuit diagram used in the specific example. As illustrated in FIG. 20, an LLC current resonance circuit having two reactors Lr and Lm and a capacitor Cr will be described as an example. As illustrated in FIG. 20, the learning and acquisition of the optimum solution are executed by using pieces of image data of node waveforms at four observation points and three parameters (Cr, Lr, Lm). The four observation points correspond to the above-described characteristic values indicating phenomena, the three parameters correspond to the variables, and the power efficiencies correspond to the above-described objective functions.

### Learning Data

Next, the pieces of learning data used for the learning of the VAE for acquiring the optimum combination of design parameters will be described. Waveforms at four observation points 1 to 4 sensitive to a change of the circuit parameter are given as pieces of multichannel image data, and a highest value of an output current that is largely influenced by a change of the power efficiency is used. It is predicted that the latent space varies depending on the output current.

Parameter values of the circuit parameters (Cr, Lr, Lm) that are sensitive to the node waveforms and the power efficiencies and are relatively easily changeable in design are given as the pieces of multichannel image data (all pixels are normalized with the parameter values and the highest value). The power efficiencies are given as the pieces of multichannel image data (all pixels are normalized with the power efficiencies). It is assumed that each image size is 120×120. As stated above, it is assumed that the number of channels is the number of observation points+the number of parameters+power efficiency=4+3+1=8. It is assumed that the number of pieces of learning data is 961. Lm is a designed value, and Lr and Cr are values obtained by fluctuating a range from −30% to +30% from designed values by steps of 2%.

In this environment, according to the specific example, a simulation is executed by randomly extracting arbitrary points in the latent space and adopting the inferred circuit parameter combination as design parameters, and it is checked whether the optimization of a circuit part is good.

### VAE

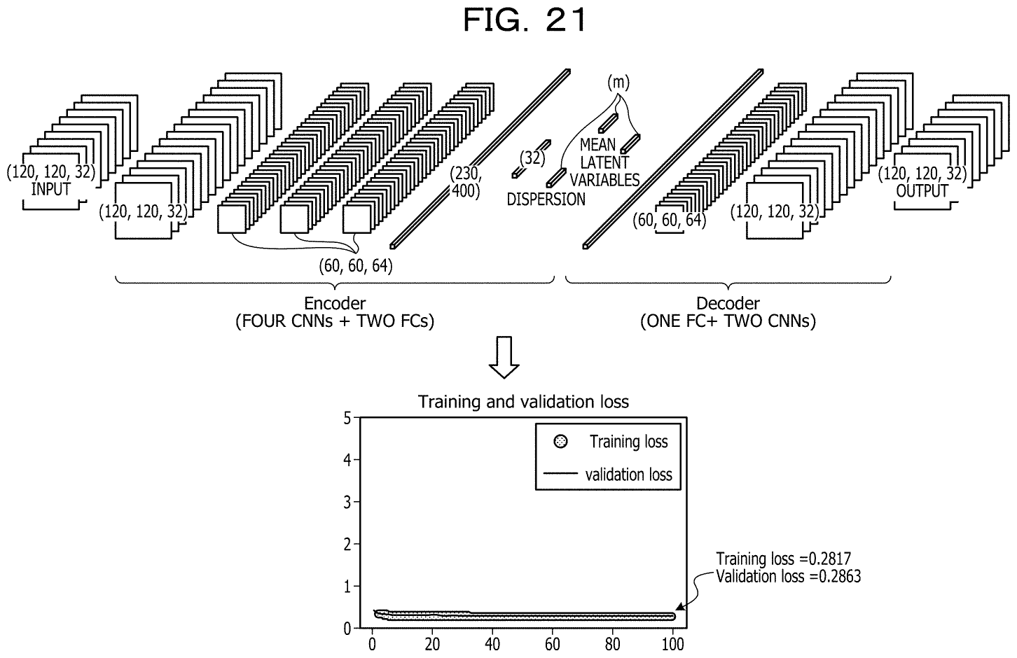

Next, the VAE to be learned will be described. FIG. 21 is a diagram for explaining a structure of the VAE that generates the latent space and losses. As illustrated in FIG. 21, the VAE to be learned includes an encoder having four convolutional neural networks (CNNs) and two full-connected (FC) layers and a decoder having one FC layer and two CNNs. The number of pieces of learning data is the square of steps of each parameter=(31)²=961. 96 pieces of data which are 10% of 961 are used as pieces of validation data, and the remaining 865 pieces of data are used as the pieces of training data. A batch size for the learning is 16, the number of epochs for learning is 100, and Nadam is used as an optimizer that is an optimization algorithm. A training time of one epoch is 3 seconds.

A lower part of FIG. 21 illustrates losses (Loss) of the learned VAE learned by such conditions. FIG. 21 has a horizontal axis indicating the number of epochs for learning and a vertical axis indicating losses. As illustrated in FIG. 21, a loss (training loss) when the pieces of training data are used is 0.2817, a loss (validation loss) when the pieces of validation data are used is 0.2863, and it is understood that the VAE may be sufficiently learned by the above-described learning conditions.

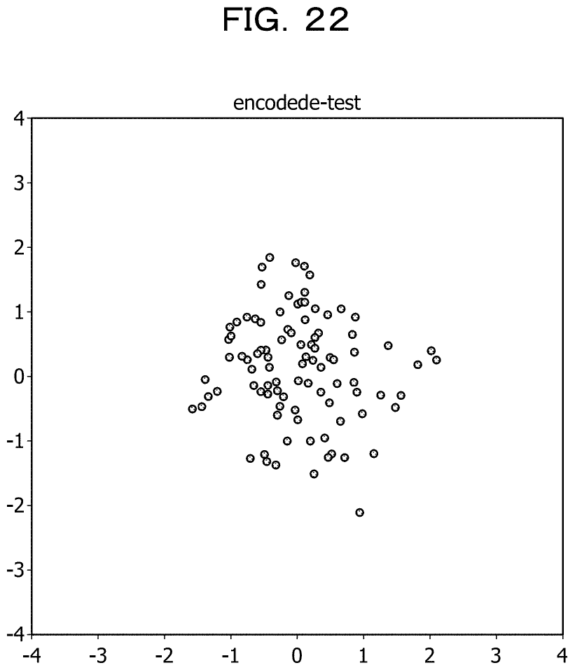

FIG. 22 illustrates a distribution of the pieces of validation data used for validation. FIG. 22 is a diagram for explaining the distribution of the pieces of validation data in the latent space. As illustrated in FIG. 22, since points over the latent space are distributed about the latent space (0, 0) and the distribution is uniform without deviations, it may be determined that the fluctuation range of the pieces of learning data is expressed and the reliability of the validation result illustrated in FIG. 21 is also high.

### Restoration Result

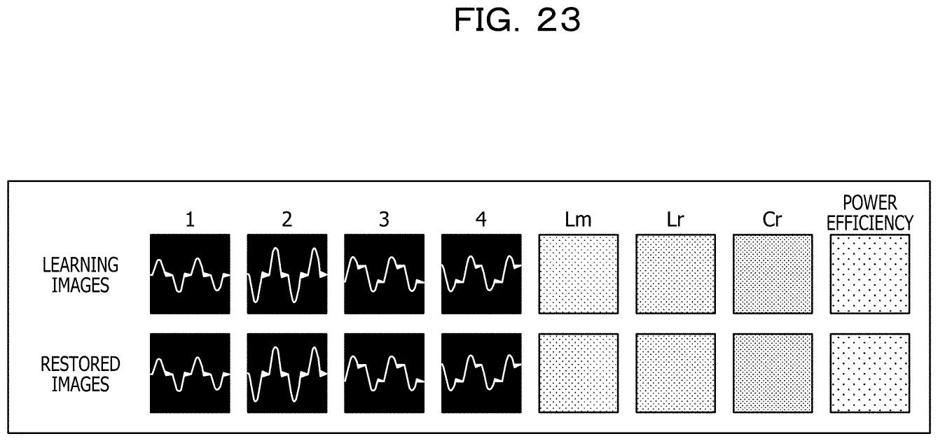

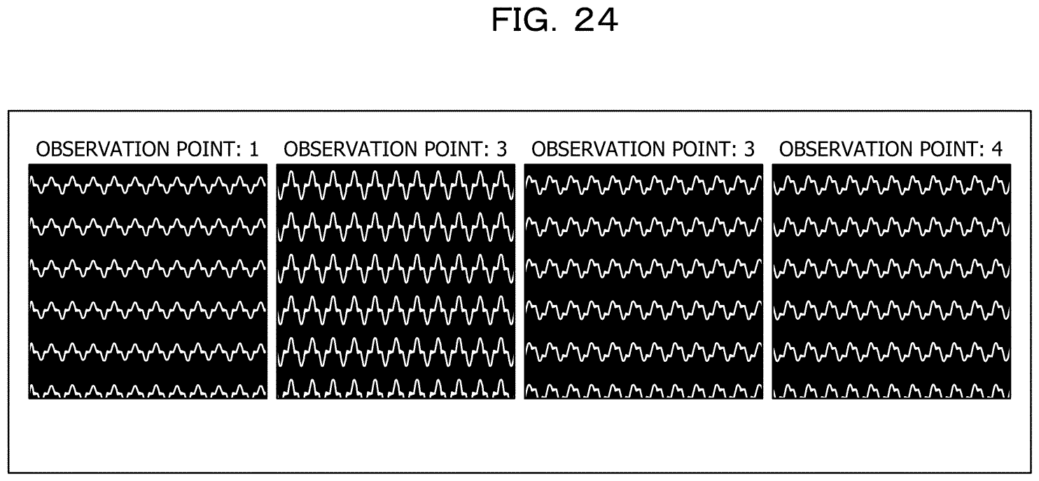

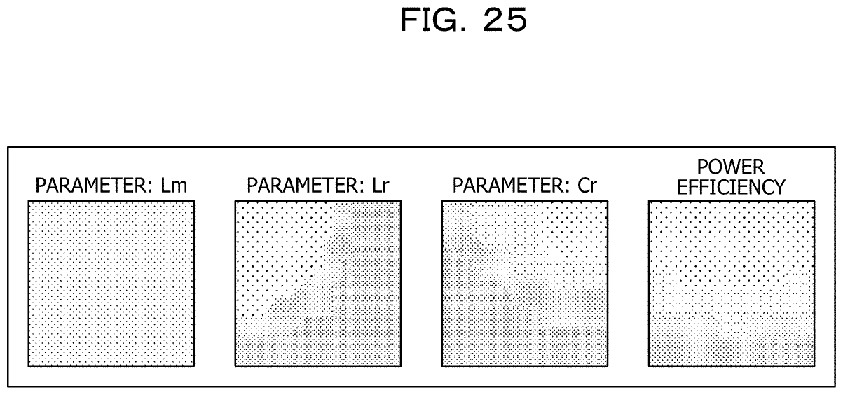

Next, the restoration result using the VAE will be described with reference to FIGS. 23 to 25. FIG. 23 is a diagram for explaining restored images of the pieces of learning data. FIG. 24 is a diagram for explaining restored images of the node waveforms in the latent space. FIG. 25 is a diagram for explaining restored images of the parameters and the power efficiencies in the latent space.

FIG. 23 illustrates images (learning images) corresponding to eight pieces of learning data of the four observation points, the three parameters, and the power efficiencies, and restored images acquired by inputting the learning images. As illustrated in FIG. 23, there is a tendency that the learning images and restored images of the observation point waveforms, the parameters, and the power efficiencies match, and it is understood that the VAE may be sufficiently learned.

FIG. 24 illustrates the restored images of the waveforms observed at observation points 1 to 4. Each observation point waveform is corrected for a time of two cycles and at an interval from a lowest amplitude to a highest amplitude. As illustrated in FIG. 24, the restored images of each observation point waveform have small fluctuations of the continuous waveforms. However, since the waveform fluctuations of the pieces of learning data are small, it may be difficult to completely grasp whether the feature amounts of the observation point waveforms may be learned.

FIG. 25 illustrates the restored images of the three parameters (Cr, Lr, Lm) and the power efficiencies. Each parameter is normalized with the highest value, and the power efficiency is normalized with the range from the lowest value to the highest value. As illustrated in FIG. 23, the restored images of the each parameter represents approximately continuous parameter fluctuations, and it may be determined that the VAE may learn the feature amounts of the parameters. Similarly, the restored images of the power efficiencies represent approximately continuous parameter fluctuations, and it may be determined that the VAE may learn the feature amounts of the power efficiencies.

### Research and Validation of Latent Space

Next, the validation result of the learned VAE by inputting the pieces of training data (pieces of input data) to the learned VAE and comparing the restoration result acquired by restoring the pieces of input data and the pieces of input data will be described.

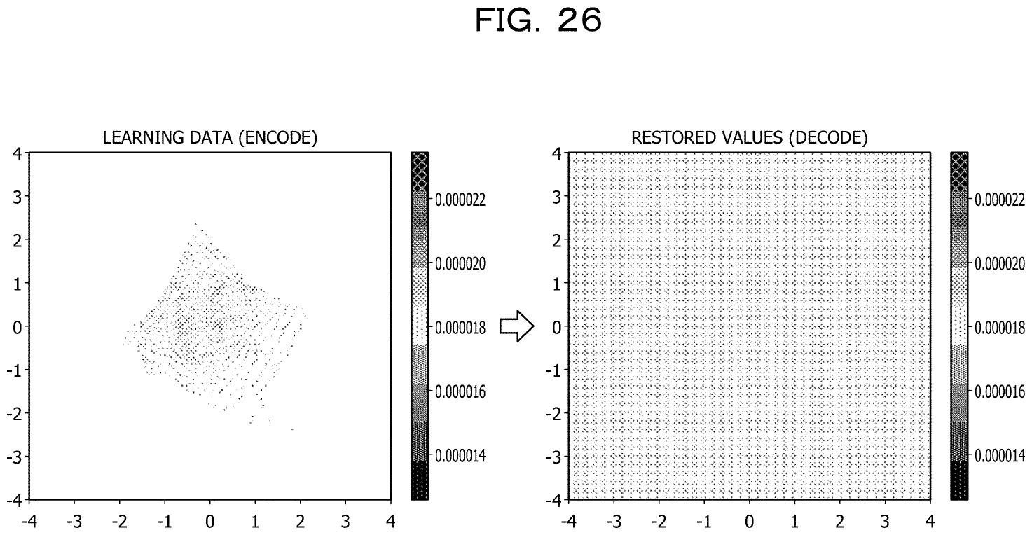

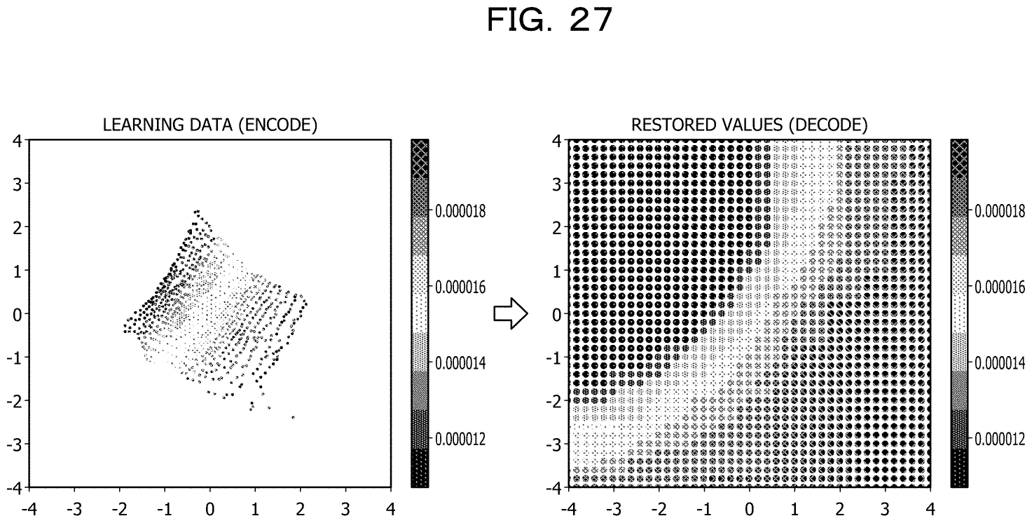

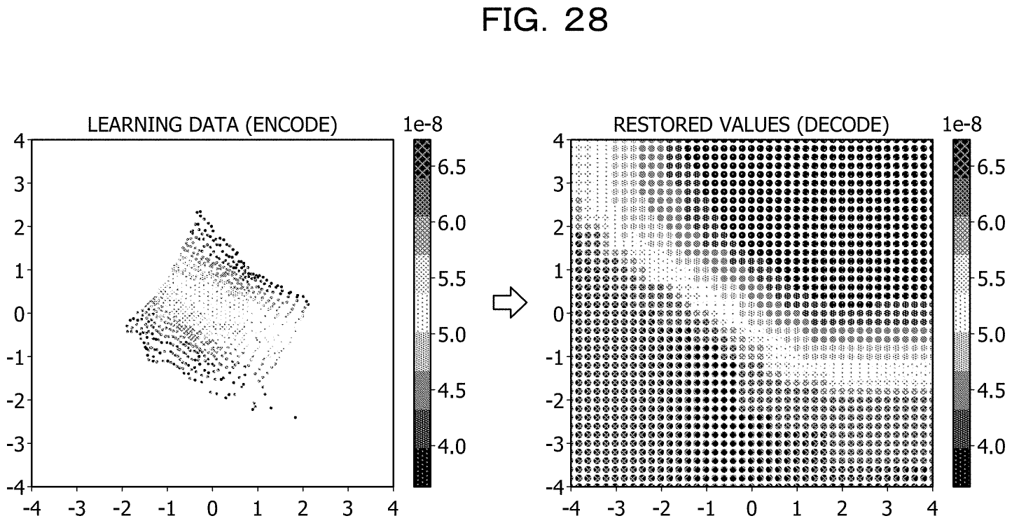

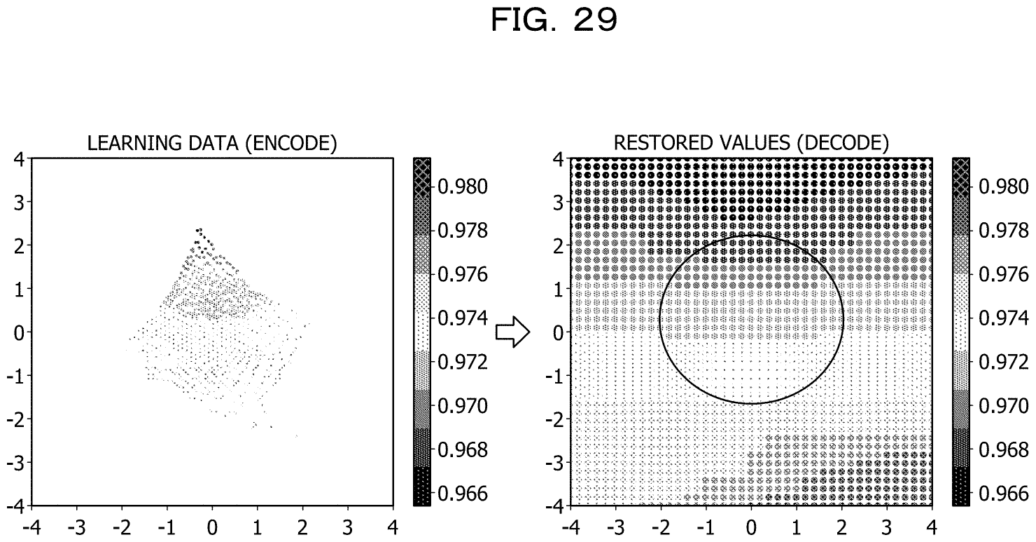

First, validation of the distribution of the each parameter will be described. FIG. 26 is a diagram for explaining a distribution of Lm parameters in the latent space. FIG. 27 is a diagram for explaining a distribution of Lr parameters in the latent space. FIG. 28 is a diagram for explaining a distribution of Cr parameters in the latent space. FIG. 29 is a diagram for explaining a distribution of the power efficiencies in the latent space. A mean value of all pixels of the restored image is adopted for each of the parameter values and the power efficiencies. FIGS. 26 to 29 illustrate the distribution of the pieces of learning data indicating that the pieces of learning data are actually classified in the latent space and a restored value indicating a value of a point sampled (extracted) over a grid from the latent space have. In FIGS. 26 to 29, a vertical axis indicates two-dimensional coordinates in the solution space formed in the latent space, and a horizontal axis is one-dimensional coordinates of the solution space formed over the latent space. A vertical numerical value represented in the horizontal axis of the distribution is the dimension of the solution space, and an example of the two dimension is illustrated. In this case, (0, 0) is a center of the solution space.

As illustrated in FIG. 26, when the distribution of the pieces of learning data of the parameters Lm input to the VAE and the restored values of the parameters Lm restored by the learned VAE are compared, the distribution tendencies of the pieces of learning data and the restored values are approximately the same tendencies (fixed values), and it may be determined that the distribution of the parameters Lm may be learned.

As illustrated in FIG. 27, when the distribution of the pieces of learning data of the parameters Lr input to the VAE and the restored values of the parameters Lr restored by the learned VAE are compared, the distribution tendencies of the pieces of learning data and the restored values are approximately the same tendencies (fixed values), and it may be determined that the distribution of the parameters Lr may be learned.

As illustrated in FIG. 28, when the distribution of the pieces of learning data of the parameters Cr input to the VAE and the restored values of the parameters Cr restored by the learned VAE are compared, the distribution tendencies of the pieces of learning data and the restored values are approximately the same tendencies (fixed values), and it may be determined that the distribution of the parameters Cr may be learned.

As illustrated in FIG. 29, when the distribution of the pieces of learning data of the power efficiencies input to the VAE and the restored values of the power efficiencies restored by the learned VAE are compared, the distribution tendencies of the pieces of learning data and the restored values are approximately the same tendencies (fixed values), and it may be determined that the distribution of the power efficiencies may be learned.

### Acquisition of Design Parameter Combination

Next, a specific example in which the sampling set is generated over the latent space by inputting the pieces of training data to the learned VAE and a combination of optimum design parameters is acquired by restoring the sampling set will be described.

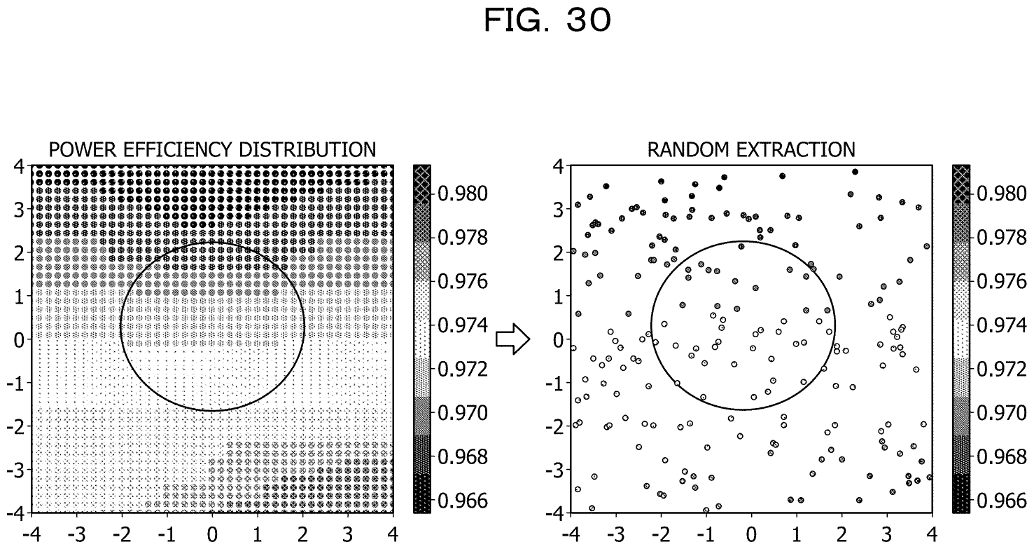

FIG. 30 is a diagram for explaining the power efficiency distribution and random extraction. As illustrated in FIG. 30, 200 arbitrary points are randomly extracted from the power efficiency distribution. Each parameter is estimated by using the extracted points, and the design parameters are acquired.

Next, a comparison between simulation values of the power efficiencies and the estimated values of the power efficiencies using the learned

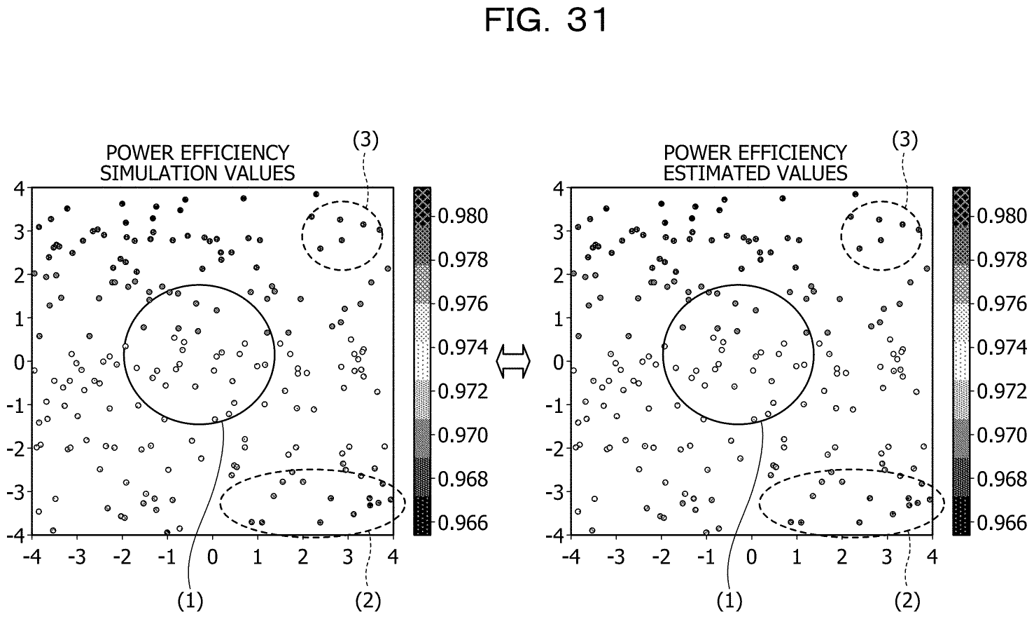

VAE will be described. FIG. 31 is a diagram for explaining the simulation values and the estimated values of the power efficiency distribution. FIG. 31 illustrates the distribution of the power efficiencies (vertical axis) in the latent space. As indicated by (1) of FIG. 31, the distributions of the power efficiencies used as the pieces of learning data have the same tendency in the simulation values and the estimated values. While the simulation values and the estimated values have slightly different tendencies in the parts of the low power efficiencies indicated by (2) of FIG. 31, the simulation values and the estimated values have the same tendency in the parts of the high power efficiencies indicated by (3) of FIG. 31.

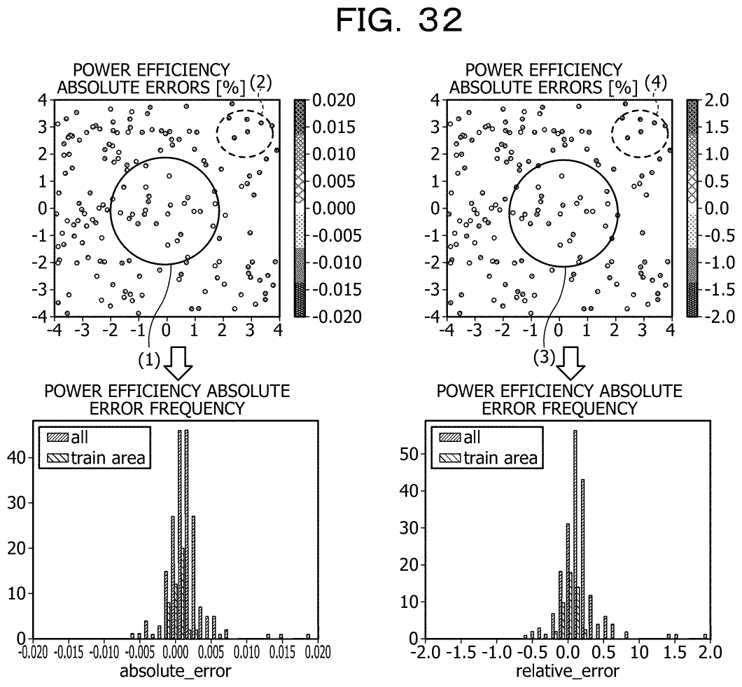

Next, errors between the simulation values of the power efficiencies and the estimated values of the power efficiencies using the learned VAE will be described. FIG. 32 is a diagram for explaining the errors between the estimated values and the simulation values. FIG. 32 illustrates distributions of absolute errors (vertical axis) and relative errors (vertical axis), respectively.

As for the absolute errors, while the absolute errors are approximately ±0.0011 or less within the pieces of learning data as indicated by (1) of FIG. 32, the errors are slightly high in a part outside the region of the pieces pf learning data as indicated by (2) of FIG. 32. A frequency distribution of the errors approximately has a normal distribution tendency.

As for the relative errors, while the relative errors are approximately ±0.12 or less within the pieces of learning data as indicated by (3) of FIG. 32, the errors are slightly high in a part outside the region of the pieces of learning data as indicated by (4) of FIG. 32. A frequency distribution of the errors approximately has a normal distribution tendency.

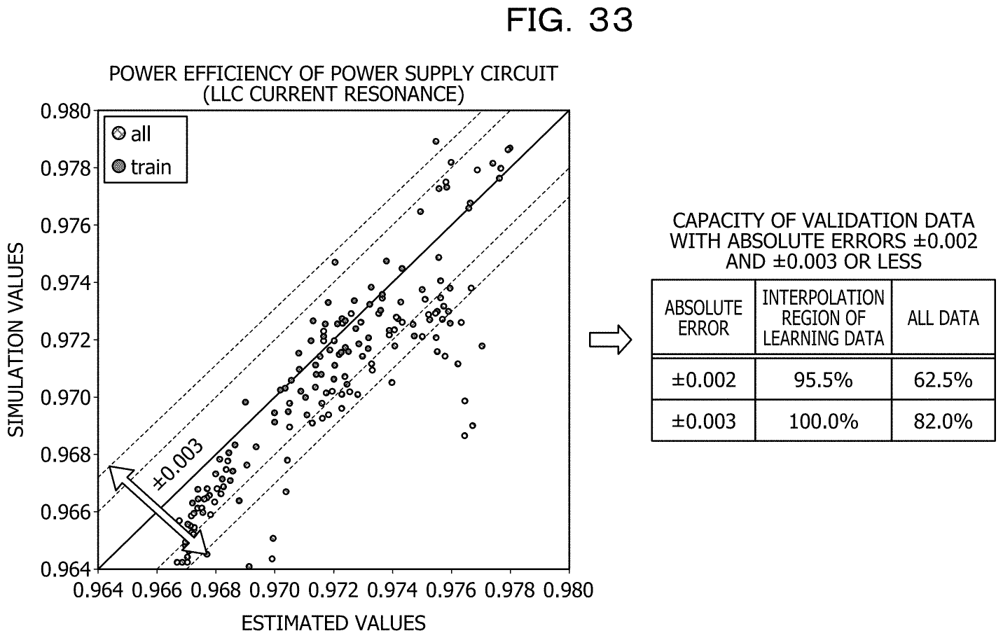

FIG. 33 is a diagram for explaining a comparison in power efficiency between the estimated values and the simulation values. FIG. 33 illustrates the simulation values and the estimated values using the learned VAE for the power efficiency of the power supply circuit (LLC current resonance) illustrated in FIG. 20. As illustrated in FIG. 33, the validation data with an absolute error of ±0.002 covers 95.5% of an interpolation region of the pieces of learning data, covers 62.5% of all the pieces of data, and the validation data with an absolute error of ±0.003 covers 100% of the interpolation region of the pieces of learning data and convers 82.0% of all the pieces of data. The data with an absolute error of ±0.003 or less contains 82% of the pieces of validation data (validated at random 200 points in a feature amount distribution), and combination candidates of parameter variables which maximize a design index are acquired.

### Optimization of Design Parameter Combination

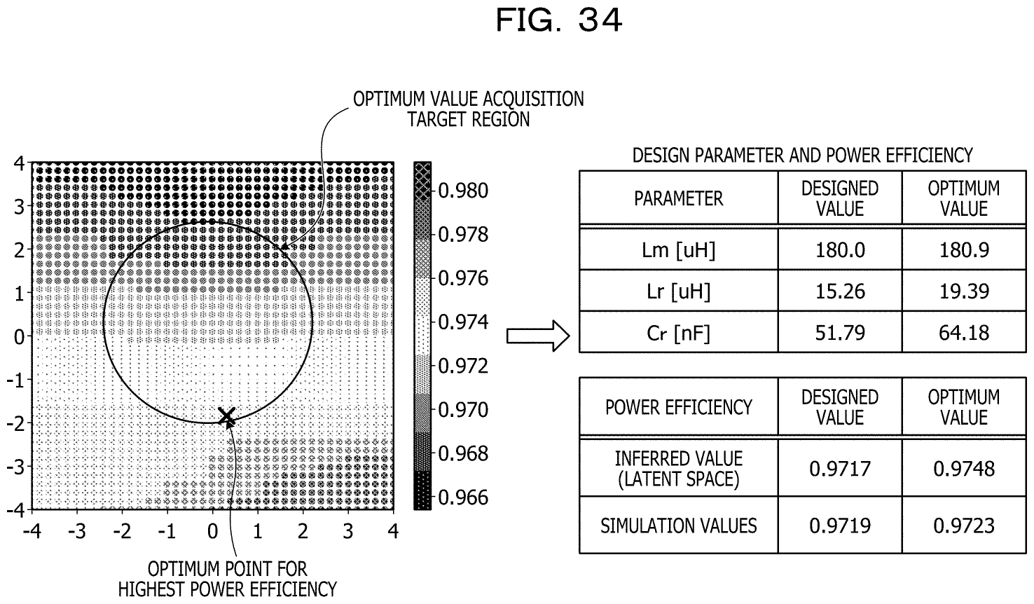

Next, acquisition of a parameter combination for the highest power efficiency from the design parameter combination obtained in FIG. 33 will be described with reference to FIG. 34. FIG. 34 is a diagram for explaining the acquisition of the optimum solution.

In the acquisition of the optimum solution illustrated in FIG. 34, 10,000 points are randomly extracted from the power efficiency distribution within the pieces of learning data, and an optimum point for the highest power efficiency over the latent space generated by the encoder of the learned VAE is acquired. Each parameter is estimated from the optimum point by using the decoder of the learned VAE, and optimum values of the design parameters are acquired.

As illustrated in FIG. 34, errors between the optimum solutions of the respective design parameters Lm, Lr, and Cr and the designed values (optimum solutions acquired over the designed values) fall within an allowable range. As for inferred values and simulation values of the power efficiencies, errors between the optimum solutions and the designed values also fall within an allowable range. For example, the optimum values acquired by using the learned VAE described in the first embodiment have the same tendency as the optimum design parameter combination in the design parameter range (within the pieces of learning data).

### Effects

As described above, the information processing apparatus 10 according to the first embodiment discriminates the adoption possibility of the optimum solution candidate at the arbitrary point in the latent space based on the sparseness or denseness of the training data distribution in the neighboring region, and adopts the optimum solution candidate when the training data distribution is dense, and does not adopt the optimum solution candidate when the training data distribution is sparse. As a result, the information processing apparatus 10 may extract the arbitrary point with high inference accuracy of the decoder from the latent space, and may acquire the accurate optimum solution.

The information processing apparatus 10 may acquire the accurate optimum solution even when the inference accuracy distribution of the decoder corresponding to the arbitrary point is unknown in the latent space. In the latent space, the information processing apparatus 10 may exclude the arbitrary point with low inference accuracy of the decoder from the candidates for the optimum solution. The information processing apparatus 10 may not validate the inference accuracy of the decoder corresponding to the arbitrary point in the latent space by experiment, mathematical calculation, or the like.

Even when the learned VAE is re-learned, the information processing apparatus 10 may easily and accurately reset the fluctuation range of each variable, and may improve the accuracy of the re-learning. For example, when the distribution of the Lm parameters in the first learning is as illustrated in FIG. 24, a distribution of pieces of learning data in the second learning may be extended or pieces of learning data for acquiring a different distribution may be generated with reference to the distribution of FIG. 24.

The information processing apparatus 10 may express and output the distribution of the pieces of training data by using the latent space of the learned VAE. Thus, even when the learned VAE is re-learned without being able to acquire the optimum solution by the learned VAE, countermeasures such as removing the pieces of training data with low density may be taken.

### Second Embodiment

While the embodiment of the present disclosure has been described, the present disclosure may be implemented in various different forms other than the above-described embodiment.

### Data, Numerical Values, and the Like

The data examples, the numerical value examples, the thresholds, the display examples, and the like used in the above-described embodiment are merely examples and may be arbitrarily changed. The training data include the objective function that is the correct solution information, and the variables and the like that influence the objective function may be arbitrarily selected. Although the example in which the objective function and the like are imaged has been described in the above-described embodiment, the present disclosure is not limited thereto. Other information such as graphs that may express the feature amounts of the images may be adopted.

The optimum solutions of the parameters in the circuit design have been described in the specific example, and are merely examples. The present disclosure is applicable to other fields. Although the example in which the variational autoencoder is used has been described in the above-described embodiment, the present disclosure is not limited thereto. Other kinds of machine learning which may aggregate the objective functions with high degrees of similarity over the latent space may be used.

### Determination of Sparseness or Denseness

Various methods may be adopted as the determination of the sparseness or denseness of the pieces of training data over the latent space. For example, the latent variables over the latent space are classified into clusters by using a clustering method, and the cluster of which the number of latent variables belonging to the own cluster is largest is selected. The latent variable of the training data that maximizes the value of the objective function among the latent variables in the selected cluster may be extracted, and the extracted latent variable may be input to the decoder.

### System

Unless otherwise specified, processing procedures, control procedures, specific names, and information including various kinds of data and parameters described in the above-described document or drawings may be arbitrarily changed.

Each element of each illustrated apparatus is of a functional concept, and may not physically constituted as illustrated in the drawings. For example, the specific form of the distribution or integration of the apparatuses is not limited to the apparatuses illustrated in the drawings. For example, the entirety or part of the apparatus may be constituted so as to be functionally or physically distributed or integrated in an arbitrary unit in accordance with various kinds of loads, usage states, or the like.

All or an arbitrary part of the processing functions performed by each apparatus may be achieved by a CPU and a program analyzed and executed by the CPU or may be achieved by a hardware apparatus using wired logic.

### Hardware

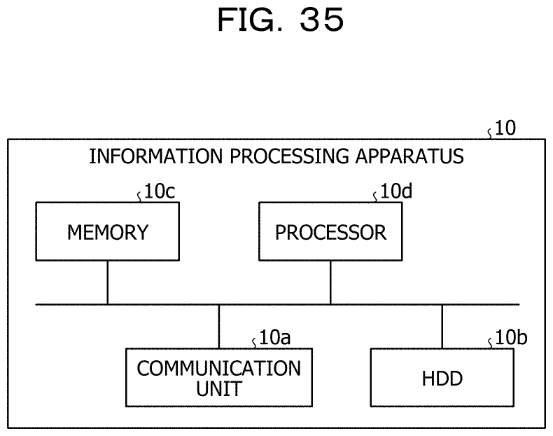

FIG. 35 is a diagram for explaining an example of a hardware configuration. As illustrated in FIG. 35, the information processing apparatus 10 includes a communication device 10a, a hard disk drive (HDD) 10b, a memory 10c, and a processor 10d. The parts illustrated in FIG. 35 are coupled to one another by a bus or the like.

The communication device 10a is a network interface card or the like and communicates with other apparatuses. The HDD 10b stores a program or a DB for operating the function illustrated in FIG. 6.

The processor 10d operates a process of executing the functions described in FIG. 6 or the like by reading out the program that executes processing similar to the processing performed by each processing unit illustrated in FIG. 6 from the HDD 10b or the like and loading the read program on the memory 10c. For example, this process executes the functions similar to the functions of the processing units included in the information processing apparatus 10. For example, the processor 10d reads out a program having the functions similar to the functions of the training data generating unit 21, the learning unit 22, the set generating unit 23, the acquiring unit 24, and the like from the HDD 10b or the like. The processor 10d executes a process of executing the processing similar to the processing of the training data generating unit 21, the learning unit 22, the set generating unit 23, the acquiring unit 24, and the like.

As described above, the information processing apparatus 10 operates as an information processing apparatus that executes a method of acquiring the optimum solution by reading out and executing the program. The information processing apparatus 10 may also achieve the functions similar to the functions of the above-described embodiments by reading out the above-described programs from a recording medium with a medium reading device and executing the above-described read programs. The programs described for another embodiment are not limited to the programs to be executed by the information processing apparatus 10. For example, the present disclosure may be similarly applied to when another computer or server executes the programs or when another computer and server execute the programs in cooperation with each other.

The program may be distributed via a network such as the Internet.

The program may be executed by being recorded on a computer-readable recording medium such as a hard disk, a flexible disk (FD), a compact disc read-only memory (CD-ROM), a magneto-optical disk (MO), a digital versatile disc (DVD) and being read out from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
learning a variational autoencoder (VAE) by using a plurality of pieces of training data including an objective function;
identifying, by inputting the plurality of pieces of training data to the learned VAE, a distribution of the plurality of pieces of training data over a latent space of the learned VAE;
determining a search range of an optimum solution of the objective function based on the distribution of the plurality of pieces of training data; and
acquiring an optimum solution of a desired objective function by using the pieces of training data included in the search range.

2. The non-transitory computer-readable storage medium according to claim 1, wherein the identifying includes
specifying the distribution of the plurality of pieces of training data over the latent space by mapping a latent variable corresponding to each of the plurality of pieces of training data generated by an encoder of the learned VAE in response to the input of the plurality of pieces of training data to the latent space of the learned VAE.

3. The non-transitory computer-readable storage medium according to claim 1, wherein the determining includes:
determining sparseness or denseness of the distribution of the plurality of pieces of training data over the latent space; and
deciding, as the search range of the optimum solution, a region in which a density is equal to or greater than a threshold.

4. The non-transitory computer-readable storage medium according to claim 3, wherein the acquiring includes:
generating a sampling set of latent variables generated from the pieces of training data belonging to the region in which the density is equal to or greater than the threshold; and
acquiring the optimum solution of the desired objective function by inputting the sampling set to a decoder of the learned VAE.

5. The non-transitory computer-readable storage medium according to claim 3, wherein the acquiring includes:
selecting one piece among the pieces of training data belonging to the region in which the density is equal to or greater than the threshold; and
acquiring the optimum solution of the desired objective function based on a restoration result obtained by inputting the latent variable generated from the selected training data to a decoder of the learned VAE.

6. An optimum solution acquisition method executed by a computer, the method comprising:
learning a variational autoencoder (VAE) by using a plurality of pieces of training data including an objective function;
identifying, by inputting the plurality of pieces of training data to the learned VAE, a distribution of the plurality of pieces of training data over a latent space of the learned VAE;
determining a search range of an optimum solution of the objective function based on the distribution of the plurality of pieces of training data; and
acquiring an optimum solution of a desired objective function by using the pieces of training data included in the search range.

7. An optimum solution acquisition apparatus, comprising:
a memory; and
a processor coupled to the memory and the processor configured to:
learn a variational autoencoder (VAE) by using a plurality of pieces of training data including an objective function,
identify, by inputting the plurality of pieces of training data to the learned VAE, a distribution of the plurality of pieces of training data over a latent space of the learned VAE,
determine a search range of an optimum solution of the objective function based on the distribution of the plurality of pieces of training data, and
acquire an optimum solution of a desired objective function by using the pieces of training data included in the search range.

8. The optimum solution acquisition apparatus according to claim 7, wherein the processor configured to
specify the distribution of the plurality of pieces of training data over the latent space by mapping a latent variable corresponding to each of the plurality of pieces of training data generated by an encoder of the learned VAE in response to the input of the plurality of pieces of training data to the latent space of the learned VAE.

9. The optimum solution acquisition apparatus according to claim 7, wherein the processor configured to:
determine sparseness or denseness of the distribution of the plurality of pieces of training data over the latent space, and
decide, as the search range of the optimum solution, a region in which a density is equal to or greater than a threshold.

10. The optimum solution acquisition apparatus according to claim 9, wherein the processor configured to:
generate a sampling set of latent variables generated from the pieces of training data belonging to the region in which the density is equal to or greater than the threshold, and
acquire the optimum solution of the desired objective function by inputting the sampling set to a decoder of the learned VAE.

11. The optimum solution acquisition apparatus according to claim 9, wherein the processor configured to:
select one piece among the pieces of training data belonging to the region in which the density is equal to or greater than the threshold, and
acquire the optimum solution of the desired objective function based on a restoration result obtained by inputting the latent variable generated from the selected training data to a decoder of the learned VAE.
